(19) United States
(12) Patent Application Publication
(10) Pub. No.: US 2024/0224106 A1
(43) Pub. Date: Jul. 4, 2024

(54) COMMUNICATION METHOD, COMMUNICATION DEVICE AND CHIP

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(73) Assignee: GUANGDONG OPPO MOBILE TELECOMMUNICATIONS CORP., LTD., Dongguan (CN)

(21) Appl. No.: 18/608,810

(22) Filed: Mar. 18, 2024

Related U.S. Application Data
(63) Continuation of application No. PCT/CN2021/124530, filed on Oct. 19, 2021.

(51) Int. Cl. H04W 24/10

(52) U.S. Cl. CPC H04W 24/10

(57) ABSTRACT

A communication method, a communication device and a chip are provided. The method is applied to a terminal device. The terminal device is configured with a first stationary criterion and a first not-at-cell-edge criterion. The terminal device is a reduced capability terminal device. The method includes an operation that the terminal device performs a neighbor cell radio resource management RRM measurement relaxation when the first stationary criterion is met.

### CROSS-REFERENCE TO RELATED APPLICATION

This is a continuation application of International Patent Application No. PCT/CN2021/124530, filed on Oct. 19, 2021, the disclosure of which is hereby incorporated by reference in its entirety.

### BACKGROUND

With the development of communication technology, the stationary criterion is introduced in some communication systems to reduce power consumption of reduced capacity (RedCap) terminal device. However, how to reduce the power consumption of RedCap terminal device by the stationary criterion is not disclosed yet.

### SUMMARY

The disclosure relates to the technical field of communication and more particularly to a communication method, a communication device and a chip, which can reduce the power consumption of a terminal device.

A first aspect of the embodiments of the disclosure provides a communication method applied to a terminal device which is configured with a first stationary criterion and a first not-at-cell-edge criterion. The terminal device is a reduced capability terminal device, and the method includes an operation that the terminal device performs a neighbor cell radio resource management RRM measurement relaxation when the first stationary criterion is met.

A second aspect of the embodiments of the disclosure provides a communication device comprising a memory for storing a program and a processor. The communication device is configured with a first stationary criterion and a first not-at-cell-edge criterion. The device is a reduced capability terminal device, and the processor is configured to invoke the program in the memory to execute a neighbor cell radio resource management RRM measurement relaxation when the first stationary criterion is met.

A third aspect of the embodiments of the disclosure provides a chip including a processor, wherein a device installed with the chip is configured with a first stationary criterion and a first not-at-cell-edge criterion, the device is a reduced capability terminal device, wherein the processor is configured for invoking a program from a memory to enable the device to execute neighbor cell radio resource management (RRM) measurement relaxation when the first stationary criterion is met.

### BRIEF DESCRIPTION OF THE DRAWINGS

FIG. 1 is an example diagram of a wireless communication system applied to an embodiment of the present disclosure.

FIG. 2 is a schematic flow chart of a communication method provided by one embodiment of the present disclosure.

FIG. 3 is a schematic flow chart of a communication method provided by another embodiment of the present disclosure.

FIG. 4 is a schematic flow chart of a communication method provided by yet another embodiment of the present disclosure.

FIG. 5 is a schematic structural diagram of a communication device provided by an embodiment of the present disclosure.

FIG. 6 is a schematic structural diagram of a device provided by an embodiment of the present disclosure.

### DETAILED DESCRIPTION

The technical solution in this disclosure will be described in conjunction with the accompanying drawings.

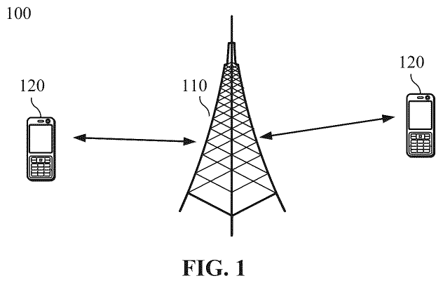

FIG. 1 shows a wireless communication system 100 to which an embodiment of the present disclosure is applied. The wireless communication system 100 may include a network device 110 and a user equipment (UE) 120. The network device 110 may communicate with the UE 120. The network device 110 may provide communication coverage for a specific geographic area and may communicate with the UE 120 within the coverage area. The UE 120 may access a network (e.g. a wireless network) through the network device 110.

FIG. 1 exemplarily illustrates one network device and two UEs. Optionally, the wireless communication system 100 may include a plurality of network devices, and other numbers of terminal devices may be deployed within the coverage of each network device, which are not limited by the embodiments of the present disclosure. Optionally, the wireless communication system 100 may also include other network entities such as a network controller, a mobility management entity and the like, which are not limited by the embodiments of the present disclosure.

It should be understood that the technical solutions of the embodiments of the present disclosure may be applied to various communication systems, such as 5th generation (5G) systems or new radio (NR), long term evolution (LTE) systems, LTE frequency division duplex (FDD) systems, LTE time division duplex (TDD), and the like. The technical solutions provided by the present disclosure can also be applied to future communication systems, such as the sixth generation mobile communication systems, satellite communication systems, etc.

The UE in the embodiments of the present disclosure may also be referred to as a terminal device, an access terminal, a subscriber unit, a subscriber station, a mobile station, a mobile station (MS), a mobile terminal (MT), a remote station, a remote terminal, a mobile device, a user terminal, a terminal, a wireless communication device, a user agent or a user device. The UE in the embodiments of the present disclosure may be a device that provides voice and/or data connectivity to a user, and may be used to connect people, objects and machines, such as handheld devices having wireless connection function, vehicle-mounted devices with wireless connection function, etc. The UE in the embodiments of the present disclosure may be a mobile phone, a tablet computer (Pad), a laptop computer, a palmtop computer, a mobile internet apparatus (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in a smart city, a wireless terminal in smart home, etc. Optionally, the UE may be used to act as a base station. For example, the UE may act as a scheduling entity that provides side link signals between UEs in V2X or D2D or the like. For example, a cellular phone and a car communicate with each other using side link signals. A cellular phone communicates with a smart home device without relaying a communication signal through base stations.

The network device in the embodiments of the present disclosure may be a device for communicating with the UE, and the network device may also be referred to as an access network device or a radio access network device, for example, the network device may be a base station. The network device in the embodiments of the present disclosure may refer to a radio access network (RAN) node (or device) that enables a UE to access a wireless network. The base station can broadly cover or replace the following names, such as a NodeB, an evolved NodeB (eNB), a next generation NodeB (gNB), a relay station, an access point, a transmitting and receiving point (TRP), a transmitting point (TP), a Master eNodeB (MeNB), a secondary eNode (SeNB), a multi-standard wireless (MSR) node, a home base station, a network controller, an access node, a wireless node, an access point (AP), a transmitting node, a transceiver node, a base band unit (BBU), a remote radio unit (RRU), an active antenna unit (AAU), a remote radio head (RRH), a central unit (CU), a distributed unit (DU), a positioning node, etc. The base station may be a macro base station, a micro base station, a relay node, a donor node or the like, or a combination thereof.

In some embodiments, the network device may be fixed or mobile. For example, a helicopter or unmanned aerial vehicle may be configured to act as a mobile network device and one or more cells may be moved depending on the location of the mobile network device. In other examples, a helicopter or unmanned aerial vehicle may be configured to function as a device for communicating with another network device. In some embodiments, the network device may refer to the CU or DU, or the network device may include CU and DU, or the network device may also include AAU.

It should be understood that the network device may be deployed on land, including indoors or outdoors, hand-held or vehicle-mounted. The network device may also be deployed on the water surface, or deployed on airplanes, balloons and satellites in the air. The network device and the scenario of the network device in the embodiment of the present disclosure is not limited in the embodiment of the present disclosure.

It should also be understood that all or part of the functions of the network device and UE in present disclosure may also be implemented by software functions running on hardware or by virtualization functions instantiated on platforms (e.g. cloud platforms).

At present, a reduced capability (RedCap) terminal device is introduced into some communication systems, and RedCap terminal device can be applied to the following multiple scenarios: an industrial wireless sensor, a video surveillance and wearables.

The industrial wireless sensors have low requirements for delay and reliability compared with URLLC, and have lower cost and power consumption than those URLLC and eMBB.

The video surveillance is used for video monitoring in smart cities, industrial factories and the like. For example, the video surveillance can be used for data collection and processing in smart cities, to monitor and control urban resources more effectively and provide more effective services for urban residents.

The wearables include smart watches, cutoffs, electronic health apparatus and some medical monitoring apparatus. These apparatuses are also small-sized.

Energy saving is a very important technical index for RedCap terminal device, especially for industrial wireless sensors and other apparatus

At present, the stationary criterion is introduced in some communication systems, and the RedCap terminal device executes the neighbor cell radio resource management (RRM) measurement relaxation according to the stationary criterion to reduce the power consumption of the RedCap terminal device. Also, a new not cell edge criterion is introduced in the communication system, and the RedCap terminal device determines whether to execute the neighbor cell RRM measurement relaxation according to the stationary criterion and the new not cell edge criterion. However, how the RedCap terminal device can determine according to the stationary criterion and the new not cell edge criterion is not disclosed yet.

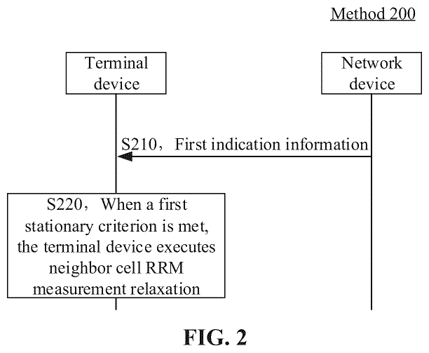

In order to solve the above technical problems, the embodiments of the present disclosure will be explained in detail with reference to FIG. 2 to FIG. 4.

FIG. 2 is a schematic flow chart of the communication method according to an embodiment of the present disclosure. It should be understood that FIG. 2 illustrates steps or operations of the communication method, but these steps or operations are only examples, and embodiments of the present disclosure may also execute other operations or variations of the respective operations in FIG. 2, or not all of the steps are executed, or the steps may be executed in other orders. The method 200 shown in FIG. 2 may include operation S220 as follows.

At S220, when a first stationary criterion is met, the terminal device executes neighbor cell RRM measurement relaxation.

The terminal device may be a reduced capacity (RedCap) terminal device, and the terminal device may be configured with a first stationary criterion and a first not-at-cell-edge criterion. The terminal device may be in an idle state or an inactive state.

The first stationary criterion is met in cases that a measurement result of the reference signal received power (RSRP) of a serving cell of the terminal device and/or a measurement result of a current reference signal receiving quality (RSRQ) of a serving cell meets the first stationary criterion. Alternatively, the first stationary criterion may be met in case that other parameters meet the first stationary criterion, which is not limited in embodiments of the present disclosure.

Optionally, the first stationary criterion may be for energy saving of the terminal device (e.g. RedCap terminal device). The first stationary criterion may be proposed by the Communication Protocol Version 17 (release 17, R17). Compared with the stationary criterion or low mobility criterion previously proposed by R17, the first stationary criterion can define different thresholds or threshold values.

For example, the first stationary criterion may indicate that the terminal device executes neighbor cell RRM measurement relaxation when a change in a measurement value of the RSRP of the serving cell of the terminal device (e.g., a change in a measurement value of the RSRP of the serving cell at a certain time or within a certain period of time) does not exceed a preset range. For example, the first stationary criterion may indicate that when the variation of a measurement value of the RSRP of the serving cell of the terminal device is less than a preset range, the terminal device executes neighbor cell RRM measurement relaxation, Alternatively, the first stationary criterion may also indicate that when the change of the measurement value of the RSRP of the serving cell of the terminal device is less than or equal to the preset range, the terminal device executes neighbor cell RRM measurement relaxation. The preset range may be different from a range value in the stationary criterion or the low mobility criterion previously proposed by R17. Alternatively, the first stationary criterion may also represent other meanings which are not limited in the embodiments of the present disclosure.

Optionally, the terminal device may also receive user subscription information sent by the network device, and the user subscription information may include stationary state indication information which may indicate whether the stationary state is met. For example, the stationary state indication information may be 1 bit. It indicates that the stationary state is met when the stationary state indication information is 1, and indicates that the stationary state is not met when the stationary state indication information is 0. In this case, the terminal device may determine whether the first stationary criterion is met according to the stationary state indication information.

Optionally, the first not-at-cell-edge criterion may be for energy saving of the terminal device (e.g. RedCap terminal device). The first not-at-cell-edge criterion may be a not cell edge criterion proposed by the Communication Protocol Version 17 (release 17, R17). The first not-at-cell-edge criterion may define a different threshold or threshold value compared to the not cell edge criterion previously proposed by R17.

For example, the first not-at-cell-edge criterion may indicate that the terminal device executes neighbor cell RRM measurement relaxation when the RSRP measurement result (e.g. the RSRP measurement result of the serving cell at a certain time or an average value of measurement values of the RSRP of the serving cell within a certain period of time, etc.) of the serving cell of the terminal device and/or the current reference signal receiving quality RSRQ measurement result of the serving cell of the terminal device exceeds the preset threshold. For example, the first not-at-cell-edge criterion can indicate that the terminal device executes neighbor cell RRM measurement relaxation when the RSRP measurement result of the serving cell of the terminal device and/or the current reference signal receiving quality RSRQ measurement result of the serving cell of the terminal device is greater than the preset threshold. Alternatively, the first not-at-cell-edge criterion can also indicate that the terminal device executes neighbor cell RRM measurement relaxation when the RSRP measurement result of the serving cell of the terminal device and/or the current reference signal receiving quality RSRQ measurement result of the serving cell of the terminal device is greater than or equal to the preset threshold. The preset range may differ from the threshold value in the not-at-cell-edge criterion previously proposed by R17. Alternatively, the first not-at-cell-edge criterion may also represent other meanings, which are not limited in embodiments of the present disclosure.

Optionally, the first not-at-cell-edge criterion may be used in conjunction with the first stationary criterion to determine whether the terminal device executes neighbor cell RRM measurement relaxation. For example, the terminal device may determine whether to execute neighbor cell RRM measurement relaxation based on the first stationary criterion and/or the first not-at-cell-edge criterion.

Optionally, the first stationary criterion and the first not-at-cell-edge criterion may be configured by a network device. For example, prior to S220, the method 200 may further include operation S210 as follows.

At S210, the network device sends a first message to the terminal device.

The first message may include the stationary criterion and the not cell edge criterion.

Optionally, the first message is a system message, a media access control control element (MAC CE) or a radio resource control (RRC) message.

For example the network device may broadcast a system message to the terminal device, the system message may be a system information block (SIB). For example, the system message may be SIB1 or another SIB.

In some embodiments, the terminal device executes first neighbor cell RRM measurement relaxation when the first stationary criterion is met and the first not-at-cell-edge criterion is not met.

Optionally, the first neighbor cell RRM measurement relaxation may be neighbor cell RRM measurement relaxation which is executed by the terminal device according to a relax requirement when the first stationary criterion is met.

For example, when the first stationary criterion is met, the requirement of executing the neighbor cell measurement by the terminal device may be magnified by K times than the requirement for the normal (non-relaxed) measurement, or an interval of the neighbor cell measurement may be magnified by K times than the interval of the normal measurement, and K is a positive integer. In other words, the requirement of executing the first neighbor cell RRM relaxation measurement by the terminal device is magnified by K times than the requirement for the normal measurement. Optionally, K may be greater than or equal to 3.

Optionally, the terminal device may also be configured with the first indication information. The first indication information may be used to instruct the terminal device to execute neighbor cell RRM measurement relaxation only when the first stationary criterion and the first not-at-cell-edge criterion are simultaneously met. For example, the first indication information may be a parameter combineRelaxedMeasCondition, which may be carried (or carried) in a system message.

For example, when the terminal device is configured with the first indication information, the terminal device can execute the first neighbor cell RRM measurement relaxation only when both the first stationary criterion and the first not-at-cell-edge criterion are met.

For another example, when the terminal device is not configured with the first indication information, the terminal device can execute the first neighbor cell RRM measurement relaxation only when the first stationary criterion is met.

In some embodiments, the terminal device may execute second neighbor cell RRM measurement relaxation when the first stationary criterion is met, the first not-at-cell-edge criterion is not met and the terminal device is not configured with the first indication information.

Optionally, the second neighbor cell RRM measurement relaxation may be neighbor cell RRM measurement relaxation which is executed by the terminal device in accordance with a relax requirement when both the first stationary criterion and the first not-at-cell-edge criterion are met.

For example, when both the first stationary criterion and the first not-at-cell-edge criterion are met, the terminal device may perform neighbor cell measurement at a measurement interval of N hours, and N is a positive number. In other words, a measurement interval of N hours may be used when the terminal device executes the second neighbor cell RRM measurement relaxation. Optionally, N may be greater than or equal to 1.

It can be seen that the requirements of the first neighbor cell RRM measurement relaxation are different from those of the second neighbor cell RRM measurement relaxation. Therefore, it can also be considered that the first neighbor cell RRM measurement relaxation and the second neighbor cell RRM measurement relaxation are two different measurement relaxation methods.

Optionally, the first indication information may be configured by a network device. For example, the first message sent by the network device to the terminal device may further include the first indication information.

In some embodiments, the terminal device executes the second neighbor cell RRM measurement relaxation when both the first stationary criterion and the first not-at-cell-edge criterion are met.

Further, the terminal device executes the second neighbor cell RRM measurement relaxation when both the first stationary criterion and the first not-at-cell-edge criterion are met and the terminal device is configured with the first indication information.

In the embodiment of the present disclosure, the terminal device is configured with the first stationary criterion and the first not-at-cell-edge criterion, and the neighbor cell RRM measurement relaxation can be executed only when the first stationary criterion is met, without meeting the first not-at-cell-edge criterion, so that the power consumption of the terminal device can be reduced to the greatest extent, thereby saving energy of the terminal device.

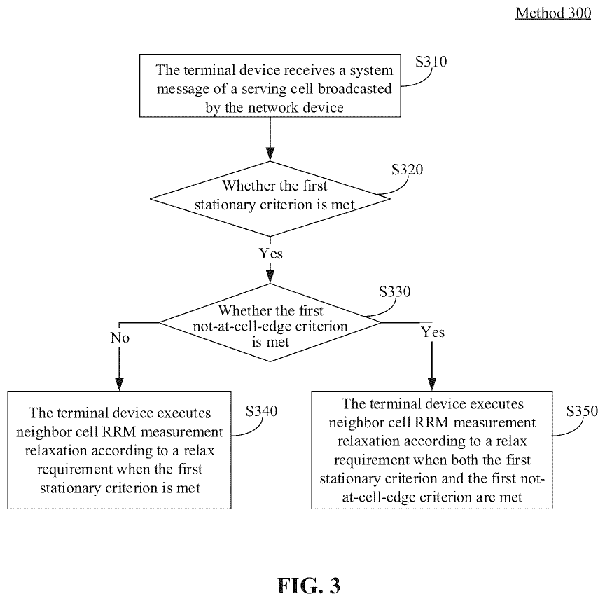

FIG. 3 is a schematic flow chart of the communication method according to an embodiment of the present disclosure. The method 300 shown in FIG. 3 may include operations S310, S320, S330, S340, and S350 as follows.

At S310, the terminal device receives a system message of the serving cell broadcasted by the network device.

The terminal device may be a reduced capacity (RedCap) terminal device, and the terminal device may be in an idle state or an inactive state.

The system message may include a first stationary criterion and a first not-at-cell-edge criterion. For example, the system message may be a system information block (SIB), for example, SIB1 or another SIB.

The terminal device may configure the first stationary criterion and the first not-at-cell-edge criterion according to the system message.

Optionally, the terminal device may receive user subscription information sent by the network device, the user subscription information may include stationary state indication information which may indicate whether the stationary state is met. For example, the stationary state indication information may be 1 bit. It indicates that the stationary state is met when the stationary state indication information is 1, and indicates that the stationary state is not met when the stationary state indication information is 0.

At S320, the terminal device determines whether the first stationary criterion is met according to the RSRP measurement result of the serving cell.

Optionally, the terminal device may determine the RSRP measurement result of the serving cell and determine whether the RSRP measurement result of the serving cell meets the first stationary criterion.

Optionally, the first stationary criterion may be for energy saving of the terminal device (e.g. RedCap terminal device). For example the first stationary criterion may be proposed by the Communication Protocol Version 17 (release 17, R17).

For example, the first stationary criterion may include at least one of the following conditions:
Condition 1, a relaxation condition of neighbor cell measurement is met in a time range TSearchDeltaP; and
Condition 2, a time which elapses from the last measurement is less than 24 hours.

The relaxation condition of neighbor cell measurement can be represented as the following formula.

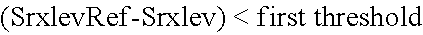

Srxlev may represent a current measurement value of a reference signal received power (RSRP) of the serving cell, SrxlevRef may represent the reference Srxlev value of the serving cell, and TSearchDeltaP may represent a preset time range (or time interval), for example, a value of TSearchDeltaP can be 5 minutes. The first threshold may represent an incremental RSRP search threshold, or the first threshold may also represent other values, which are not limited in embodiments of the present disclosure.

In practical, the conditions included in the first stationary criterion in the above-mentioned embodiment are only illustrative and not limiting, and the first stationary criterion may also include other conditions in the embodiment of the present disclosure, which are not limited in embodiment of the present disclosure.

In case that the measurement result of the RSRP of the serving cell meets the first stationary criterion, S330 may be executed. Otherwise the terminal device may drop out the flow shown in FIG. 3 (the branch is not shown in FIG. 3) without executing neighbor cell RRM measurement relaxation.

At S330, the terminal device determines whether the first not-at-cell-edge criterion is met according to the measurement result of the RSRP of the serving cell.

Optionally, the terminal device may determine whether the measurement result of the RSRP of the serving cell meets the first not-at-cell-edge criterion.

Optionally, the first not-at-cell-edge criterion may also be for energy saving of the terminal device (e.g. RedCap terminal device). For example, the first not-at-cell-edge criterion may be a not-at-cell-edge criterion proposed by the Communication Protocol Version 17 (release 17, R17).

For example, the first not-at-cell-edge criterion may include at least one of the following conditions:
Condition 1: (Srxlev)>second threshold; and
Condition 2: (Squal)>third threshold.

Srxlev may represent a current measurement value of the RSRP of the serving cell, and Squal may represent a current reference signal receiving quality (RSRQ) value of the serving cell. The second threshold value may represent an RSRP threshold of the inter-frequency measurement, and the third threshold value may represent the RSRQ threshold of the inter-frequency measurement. Alternatively, the second threshold value and the third threshold value may also represent other values, which are not limited in the embodiment of the present disclosure.

In practical, the conditions included in the first not-at-cell-edge criterion in the above-mentioned embodiment are only illustrative and not limiting, and the first not-at-cell-edge criterion may also include other conditions in the embodiment of the present disclosure, which are not limited in the embodiment of the present disclosure.

S340 may be executed in case that the measurement result of the RSRP of the serving cell does not satisfy the first not-at-cell-edge criterion. S350 may be executed in case that the measurement result of the RSRP of the serving cell meets the first not-at-cell-edge criterion.

At S340, the terminal device executes the neighbor cell RRM measurement relaxation according to the relax requirement when the first stationary criterion is met.

Optionally, when the first stationary criterion is met, the interval of performing neighbor cell measurement by the terminal device may be amplified to K times of the interval of normal measurement, K being a positive integer. Optionally, K may be greater than or equal to 3.

In practical, in case of meeting the first stationary criterion, the terminal device may also execute neighbor cell measurement according to other methods, which are not limited in the embodiment of the present disclosure.

At S350, the terminal device executes the neighbor cell RRM measurement relaxation according to the relax requirement when both the first stationary criterion and the first not-at-cell-edge criterion are met.

Optionally, when both the first stationary criterion and the first not-at-cell-edge criterion are met, the terminal device may execute neighbor cell measurement at a measurement interval of N hours, and N is a positive number. Optionally, N may be greater than or equal to 1.

In practical, in case that both the first stationary criterion and the first not-at-cell-edge criterion are met, the terminal device can also execute neighbor cell measurement according to other methods, which is not limited in the embodiment of the present disclosure.

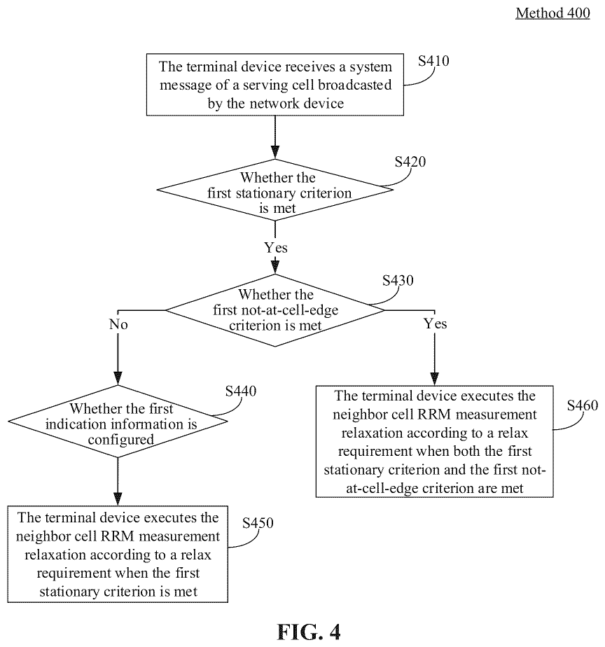

FIG. 4 is a schematic flow chart of a communication method according to an embodiment of the present disclosure. The method 400 shown in FIG. 4 may include operations S410, S420, S430, S440, S450 and S460 as follows.

At S410, the terminal device receives a system message of a serving cell broadcasted by the network device.

The terminal device may be a reduced capacity (RedCap) terminal device, and the terminal device may be in an idle state or an inactive state.

The system message may include the first stationary criterion and the first not-at-cell-edge criterion. For example, the system message may be a system information block (SIB), for example, SIB1 or another SIB.

The terminal device may configure the first stationary criterion and the first not-at-cell-edge criterion according to the system message.

At S420, the terminal device determines whether the first stationary criterion is met according to a measurement result of an RSRP of the serving cell.

Optionally, the terminal device may determine the measurement result of the RSRP of the serving cell, and determine whether the measurement result of the RSRP of the serving cell meets the first stationary criterion.

Optionally, the first stationary criterion may be for energy saving of the terminal device (e.g. RedCap terminal device). For example the first stationary criterion may be proposed by the Communication Protocol Version 17 (release 17, R17).

For example, the first stationary criterion may include at least one of the following conditions:
Condition 1, a relaxation condition of neighbor cell measurement is met in a time range TSearchDeltaP; and
Condition 2, a time which elapses from the last measurement is less than 24 hours.

The relaxation condition of neighbor cell measurement can be represented as the following formula.

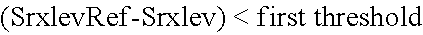

Srxlev may represent a current measurement value of a reference signal received power (RSRP) of the serving cell, SrxlevRef may represent the reference Srxlev value of the serving cell, and TSearchDeltaP may represent a preset time range (or time interval), for example, a value of TSearchDeltaP can be 5 minutes. The first threshold may represent an incremental RSRP search threshold, or the first threshold may also represent other values, which are not limited in embodiments of the present disclosure.

In practical, the conditions included in the first stationary criterion in the above-mentioned embodiment are only illustrative and not limiting, and the first stationary criterion may also include other conditions in the embodiment of the present disclosure, which are not limited in embodiment of the present disclosure.

In case that the measurement result of the RSRP of the serving cell meets the first stationary criterion, S430 may be executed. Otherwise, the terminal device may drop out the flow shown in FIG. 4 (the branch is not shown in FIG. 4) without executing neighbor cell RRM measurement relaxation.

At S430, the terminal device determines whether the first not-at-cell-edge criterion is met according to the measurement result of the RSRP of the serving cell.

Optionally, the terminal device may determine whether the measurement result of the RSRP of the serving cell meets the first not-at-cell-edge criterion.

Optionally, the first not-at-cell-edge criterion may also be for energy saving of the terminal device (e.g. RedCap terminal device). For example, the not-at-cell-edge criterion corresponding to the terminal device may be a not-at-cell-edge criterion proposed by the Communication Protocol Version 17 (release 17, R17).

The first not-at-cell-edge criterion may include at least one of the following conditions:
Condition 1: (Srxlev)>second threshold; and
Condition 2: (Squal)>third threshold.

Srxlev may represent a current measurement value of the RSRP of the serving cell, and Squal may represent a current reference signal receiving quality (RSRQ) value of the serving cell. The second threshold value may represent an RSRP threshold of the inter-frequency measurement, and the third threshold value may represent the RSRQ threshold of the inter-frequency measurement. Alternatively, the second threshold value and the third threshold value may also represent other values, which are not limited in the embodiment of the present disclosure.

In practical, the conditions included in the first not-at-cell-edge criterion in the above-mentioned embodiment are only illustrative and not limiting, and the first not-at-cell-edge criterion may also include other conditions in the embodiment of the present disclosure, which are not limited in the embodiment of the present disclosure.

S440 may be executed in case that the measurement result of the RSRP of the serving cell does not satisfy the first not-at-cell-edge criterion. S460 may be executed in case that the measurement result of the RSRP of the serving cell meets the first not-at-cell-edge criterion.

At S440, whether the terminal device is configured with the first indication information is determined.

The first indication information may be used to instruct the terminal device to execute neighbor cell RRM measurement relaxation only when both the first stationary criterion and the first not-at-cell-edge criterion are met.

Optionally, the first indication information may be configured by a network device. For example, the system message sent by the network device to the terminal device may further include the first indication information.

Accordingly, the terminal device may be configured with the first indication information according to the system message.

Optionally, the first indication information may be a parameter combineRelaxedMeasCondition. The first indication information may be carried in the system message.

If the terminal device is configured with the first indication information and meets both the first stationary criterion and the first not-at-cell-edge criterion, the operation S460 can be executed. If the terminal device is not configured with the first indication information, and meets both the stationary criterion and the first not-at-cell-edge criterion, the operation S460 can be executed. If the terminal device is not configured with the first indication information and meets the first stationary criterion, the operation S450 may be executed.

At S450, the terminal device executes the neighbor cell RRM measurement relaxation according to the relax requirement when the first stationary criterion is met.

Optionally, when the first stationary criterion is met, the interval of performing neighbor cell measurement by the terminal device may be amplified to K times of the interval of normal measurement, K being a positive integer. Optionally, K may be greater than or equal to 3.

In practical, in case of meeting the first stationary criterion, the terminal device may also execute neighbor cell measurement according to other methods, which is not limited in the embodiment of the present disclosure.

At S460, the terminal device executes the neighbor cell RRM measurement relaxation according to the relax requirement when both the first stationary criterion and the first not-at-cell-edge criterion are met.

Optionally, when both the first stationary criterion and the first not-at-cell-edge criterion are met, the terminal device may execute neighbor cell measurement at a measurement interval of N hours, and N is a positive number. Optionally, N may be greater than or equal to 1.

In practical, in case that both the first stationary criterion and the first not-at-cell-edge criterion are met, the terminal device can also execute neighbor cell measurement according to other methods, which is not limited in the embodiment of the present disclosure.

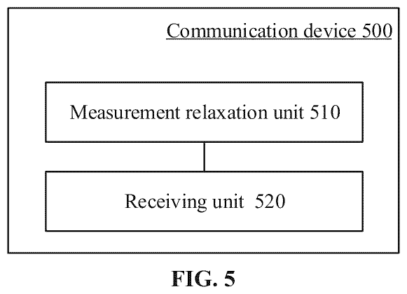

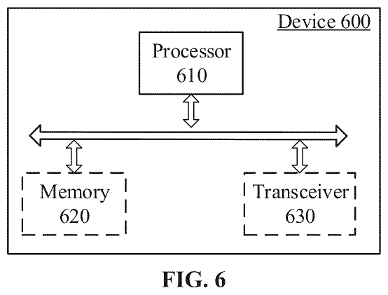

The method embodiments of the present disclosure are described in detail above with reference to FIG. 1 to FIG. 4, and device embodiments of the present disclosure are described in detail below with reference to FIG. 5 and FIG. 6. It should be understood that the description of the method embodiment corresponds to the description of the device embodiment, and regarding the parts not described in detail, reference may be made to the preceding method embodiment.

FIG. 5 is a schematic structural diagram of a communication device provided by an embodiment of the present disclosure. The device 500 is configured with a first stationary criterion and the first not-at-cell-edge criterion, the device 500 is a reduced capability terminal device. As shown in FIG. 5, the device 500 includes a measurement relaxation unit 510 as follows.

The measurement relaxation unit 510 is configured to execute a neighbor cell radio resource management RRM measurement relaxation when the first stationary criterion is met.

Optionally, the measurement relaxation unit 510 is configured to: execute first neighbor cell RRM measurement relaxation when the first stationary criterion is met and the first not-at-cell-edge criterion is not met; and execute second neighbor cell RRM measurement relaxation when both the first stationary criterion and the first not-at-cell-edge criterion are met.

Optionally, the device is further configured with first indication information for indicating that the device executes neighbor cell RRM measurement relaxation only when the first stationary criterion and the first not-at-cell-edge criterion are met. The measurement relaxation unit 510 is configured to not execute first neighbor cell RRM measurement relaxation when the first stationary criterion is met and the first not-at-cell-edge criterion is not met.

Optionally, the first neighbor cell RRM measurement relaxation is neighbor cell RRM measurement relaxation which executed by the device according to a relax requirement when the first stationary criterion is met.

Optionally, the second neighbor cell RRM measurement relaxation is neighbor cell RRM measurement relaxation which is executed by the device in accordance with a relax requirement when both the first stationary criterion and the first not-at-cell-edge criterion are met.

Optionally the device further includes a receiving unit 520 configured to receive a first message including the first stationary criterion and the first not-at-cell-edge criterion.

Optionally, the first message further includes the first indication information.

Optionally, the first message is a system message, a medium access control control element MAC CE, or a radio resource control RRC message.

FIG. 6 is a schematic structural diagram of a device provided by an embodiment of the present disclosure. The dotted line in FIG. 6 indicates that the unit or module is optional. The device 600 may be used to implement the methods described in the above method embodiments. The device 600 may be a chip or a communication device.

The device 600 may include one or more processors 610. The processor 610 may support the device 600 to implement the methods described previously in the method embodiments. The processor 610 may be a general purpose processor or a special purpose processor. For example, the processor may be a central processing unit (CPU). Alternatively, the processor may also be other general purpose processors, digital signal processors (DSP), application specific integrated circuits (ASIC), field programmable gate arrays (FPGA) or other programmable logic apparatuses, discrete gate or transistor logic apparatuses, discrete hardware components, and the like. The general purpose processor may be a microprocessor or the processor may be any conventional processor or the like.

The device 600 may also include one or more memories 620. The memory 620 stores a program that can be executed by the processor 610 such that processor 610 executes the methods described previously in the method embodiments. The memory 620 may be independent of the processor 610 or may be integrated within the processor 610.

The device 600 may also include a transceiver 630. The processor 610 may communicate with other devices or chips through the transceiver 630. For example the processor 610 may transmit and receive data with other devices or chips through the transceiver 630.

The embodiment of the present disclosure further provides a computer-readable storage medium for storing a program. The computer-readable storage medium may be applied to the communication device provided by embodiments of the present disclosure, and the program causes the computer to execute the methods executed by the communication device in the various embodiments of the present disclosure.

The embodiment of the present disclosure further provides a computer program product. The computer program product includes a program. The computer program product may be applied to the communication device provided by embodiments of the present disclosure, and the program causes the computer to execute the methods executed by the communication device in the various embodiments of the present disclosure.

The embodiment of the present disclosure further provides a computer program. The computer program may be applied to the communication device provided by embodiments of the present disclosure, and the computer program causes the computer to execute the methods executed by the communication device in the various embodiments of the present disclosure.

It should be understood that, in embodiments of the present disclosure, “B corresponding to A” means that B is associated with A and B may be determined according to A. However, it should also be understood that determining B according to A does not mean that B is determined only according to A, but B may also be determined according to A and/or other information.

It should be understood that the term “and/or” used herein merely indicates an association relationship that describes associated objects, indicating three relationships. For example, A and/or B may indicate three cases where A exists alone, both A and B exist, and B exists alone. In addition, the character “/” used herein generally indicates a “or” relationship between related objects.

It should be understood that in various embodiments of the present disclosure, the sequence number of the above-mentioned processes does not define an execution order, and the execution order of each process should be determined by the function and inherent logic of the process, and should not be used for limiting the implementation process of the embodiments of the present disclosure in any way.

In several embodiments provided herein, it should be understood that the disclosed systems, devices and methods may be implemented in other ways. For example, the above-described device embodiments are only illustrative, for example, the division of the unit is only a logical function division, and other division methods may also be used in actual implementation, for example, multiple units or components may be combined or integrated into another system, or some features may be ignored or not executed. On the other hand, the coupling or direct coupling or communication connection between the units or components shown or discussed may be indirect coupling or communication connection through some interface, device or unit, and may be electrical, mechanical or other form.

The units illustrated as separate components may or may not be physically separated, and the components displayed as units may or may not be physical units, i.e. may be located in one place, or may be distributed over a plurality of network units. Part or all of the units can be selected according to the actual needs to achieve the purpose of the embodiment.

In addition, the functional units in each embodiment of the present disclosure may be integrated in one processing unit, or each of the functional units may exist physically alone, or two or more units may be integrated in one unit.

The above-described embodiments may be implemented in whole or in part by software, hardware, firmware, or any combination thereof. When implemented by software, the embodiments may be implemented in whole or in part in the form of a computer program product. The computer program product includes one or more computer instructions. When the computer program instructions are loaded and executed on the computer, the processes or functions described in accordance with embodiments of the present disclosure are generated in whole or in part. The computer may be a general purpose computer, a special purpose computer, a computer network, or other programmable device. The computer instructions may be stored in a computer-readable storage medium or transmitted from one computer-readable storage medium to another computer-readable storage medium, for example, the computer instructions may be transmitted from one Web site, computer, server, or data center to another Web site, computer, server, or data center via a wired manner (e.g. coaxial cable, optical fiber, digital subscriber line (DSL)) or a wireless manner (e.g. infrared, wireless, microwave, etc.). The computer-readable storage medium may be any usable medium that can be read by the computer or a data storage device such as a server or a data center that includes one or more usable mediums which are integrated. The usable medium may be a magnetic medium (e.g. a floppy disk, a hard disk, a magnetic tape), an optical media (e.g. a digital video disc (DVD)), or a semiconductor media (e.g. a solid state disk (SSD)), etc.

Only the specific implementations of the present disclosure are described above, but the scope of protection of the present disclosure is not limited thereto. The changes or substitutions conceived by any technical person familiar with the technical field within the technical scope disclosed in the present disclosure should be covered within the scope of protection of the present disclosure. Therefore, the scope of protection of present disclosure shall be subject to the scope of protection of the claims.

1. A communication method applied to a terminal device, wherein the terminal device is configured with a first stationary criterion and a first not-at-cell-edge criterion, the terminal device is a reduced capability terminal device, the method comprising:
executing, by the terminal device, neighbor cell radio resource management (RRM) measurement relaxation when the first stationary criterion is met.

2. The method according to claim 1, wherein the executing, by the terminal device, the neighbor cell RRM measurement relaxation when the first stationary criterion is met comprises:
executing, by the terminal device, first neighbor cell RRM measurement relaxation when the first stationary criterion is met and the first not-at-cell-edge criterion is not met; and
executing, by the terminal device, second neighbor cell RRM measurement relaxation when both the first stationary criterion and the first not-at-cell-edge criterion are met.

3. The method according to claim 1, wherein the terminal device is further configured with first indication information, and the first indication information indicates that the terminal device executes neighbor cell RRM measurement relaxation only when both the first stationary criterion and the first not-at-cell-edge criterion are met,
the executing, by the terminal device, the neighbor cell RRM measurement relaxation when the first stationary criterion is met comprises:
not executing, by the terminal device, first neighbor cell RRM measurement relaxation when the first stationary criterion is met and the first not-at-cell-edge criterion is not met.

4. The method according to claim 2, wherein the first neighbor cell RRM measurement relaxation is neighbor cell RRM measurement relaxation which is executed by the terminal device in accordance with a relax requirement when the first stationary criterion is met.

5. The method according to claim 2, wherein the second neighbor cell RRM measurement relaxation is neighbor cell RRM measurement relaxation which is executed by the terminal device in accordance with a relax requirement when both the first stationary criterion and the first not-at-cell-edge criterion are met.

6. The method according to claim 1, further comprising: before the executing, by the terminal device, the neighbor cell RRM measurement relaxation,
receiving, by the terminal device, a first message, the first message comprising the first stationary criterion and the first not-at-cell-edge criterion.

7. The method according to claim 6, wherein the first message further comprises first indication information.

8. The method according to claim 6, wherein the first message is a system message, a medium access control control element (MAC CE) or a radio resource control (RRC) message.

9. A communication device comprising a memory for storing a program and a processor, wherein the communication device is configured with a first stationary criterion and a first not-at-cell-edge criterion, the terminal device is a reduced capability terminal device, and wherein the processor is configured to invoke the program in the memory to:
execute neighbor cell radio resource management (RRM) measurement relaxation when the first stationary criterion is met.

10. The communication device according to claim 9, wherein the processor is configured to invoke the program in the memory to:
execute first neighbor cell RRM measurement relaxation when the first stationary criterion is met and the first not-at-cell-edge criterion is not met; and
execute second neighbor cell RRM measurement relaxation when both the first stationary criterion and the first not-at-cell-edge criterion are met.

11. The communication device according to claim 9, wherein the communication device is further configured with first indication information, and the first indication information indicates that the communication device executes neighbor cell RRM measurement relaxation only when both the first stationary criterion and the first not-at-cell-edge criterion are met,
the processor is configured to invoke the program in the memory to:
not execute first neighbor cell RRM measurement relaxation when the first stationary criterion is met and the first not-at-cell-edge criterion is not met.

12. The communication device according to claim 10, wherein the first neighbor cell RRM measurement relaxation is neighbor cell RRM measurement relaxation which is executed by the communication device in accordance with a relax requirement when the first stationary criterion is met.

13. The communication device according to claim 10, wherein the second neighbor cell RRM measurement relaxation is neighbor cell RRM measurement relaxation which is executed by the communication device in accordance with a relax requirement when both the first stationary criterion and the first not-at-cell-edge criterion are met.

14. The communication device according to claim 9, further comprising a transceiver,
wherein the processor is configured to invoke the program in the memory to control the transceiver to receive a first message, the first message comprising the first stationary criterion and the first not-at-cell-edge criterion.

15. The communication device according to claim 14, wherein the first message further comprises first indication information.

16. The communication device according to claim 14, wherein the first message is a system message, a medium access control control element (MAC CE) or a radio resource control (RRC) message.

17. A chip comprising a processor, wherein a device installed with the chip is configured with a first stationary criterion and a first not-at-cell-edge criterion, the device is a reduced capability terminal device, wherein the processor is configured for invoking a program from a memory to enable the device to:
execute neighbor cell radio resource management (RRM) measurement relaxation when the first stationary criterion is met.

18. The chip according to claim 17, wherein the processor is configured for invoking the program from the memory to enable the device to:
execute first neighbor cell RRM measurement relaxation when the first stationary criterion is met and the first not-at-cell-edge criterion is not met; and
execute second neighbor cell RRM measurement relaxation when both the first stationary criterion and the first not-at-cell-edge criterion are met.

19. The chip according to claim 17, wherein the device is further configured with first indication information, and the first indication information indicates that the device executes neighbor cell RRM measurement relaxation only when both the first stationary criterion and the first not-at-cell-edge criterion are met,
the processor is configured for invoking the program from the memory to enable the device to:
not execute first neighbor cell RRM measurement relaxation when the first stationary criterion is met and the first not-at-cell-edge criterion is not met.

20. The chip according to claim 18, wherein the first neighbor cell RRM measurement relaxation is neighbor cell RRM measurement relaxation which is executed by the device in accordance with a relax requirement when the first stationary criterion is met.
